(19) United States
(12) Patent Application Publication
(10) Pub. No.: US 2021/0181712 A1
(43) Pub. Date: Jun. 17, 2021

(54) CONTROL DEVICE AND CONTROL METHOD

(71) Applicant: FANUC CORPORATION, Minamitsuru-gun (JP)

(72) Inventor: Shinichi OZEKI, Yamanashi (JP)

(21) Appl. No.: 16/953,867

(22) Filed: Nov. 20, 2020

(30) Foreign Application Priority Data
Dec. 13, 2019 (JP) 2019-225153

(51) Int. Cl. G05B 19/4097

(52) U.S. Cl. CPC G05B 19/4097; G05B 2219/31449; G05B 2219/35012

(57) ABSTRACT

To reliably execute processing to be prioritized for each processing state for an industrial machine. A control device executes processing of processing requests for a machine tool from a client, the numerical control device including: a processing switching unit configured to switch, in a case in which a plurality of the processing requests is received from the client, an order of processing for each of the plurality of processing requests based on a priority according to a processing state for the machine tool.

This application is based on and claims the benefit of priority from Japanese Patent Application No. 2019-225153, filed on 13 Dec. 2019, the content of which is incorporated herein by reference.

### BACKGROUND OF THE INVENTION

### Field of the Invention

The present invention relates to a control device and a control method.

### Related Art

Among control devices for controlling an industrial machine, there are control devices which include a server that communicates with clients such as a display device and a tablet and, in response to a processing request from the client to the control device, perform processing relating to the industrial machine. In this case, conventionally, the control device executes the processing relating to the industrial machine in the order of the processing request received from the client.

In this regard, a technique has been known for communication between a general client and a server, in which a priority is set in advance for each piece of information to be communicated, and the communication is performed based on the priority that was set. For example, see Patent Document 1.
Patent Document 1: Japanese Unexamined Patent Application, Publication No. H10-289188

### SUMMARY OF THE INVENTION

However, if the priority is set uniformly for each processing request in the control device for controlling the industrial machine, when giving a machine tool as an example of the industrial machine, the processing request that is desired to be prioritized differs depending on the processing state of the machine tool (for example, during machining (MEM mode), EDIT mode, etc.). Therefore, the control device may not always be able to perform the processing to be performed immediately, depending on the processing state of the machine tool.

Therefore, it has been desired to reliably execute processing to be prioritized for each processing state for an industrial machine.

An aspect of the control device of the present disclosure relates to a control device that executes processing of processing requests for an industrial machine from a client, the control device including: a processing switching unit configured to switch, in a case in which a plurality of the processing requests is received from the client, an order of processing for each of the plurality of processing requests based on a priority according to a processing state for the industrial machine.

An aspect of the control method of the present disclosure relates to a control method for executing processing of processing requests for an industrial machine from a client, the method including: switching, in a case in which a plurality of the processing requests is received from the client, an order of processing for each of the plurality of the processing requests based on a priority according to a processing state for the industrial machine.

According to one aspect, it is possible to reliably execute processing to be prioritized for each processing state for an industrial machine.

### BRIEF DESCRIPTION OF THE DRAWINGS

FIG. 1 is a functional block diagram showing a functional configuration example of a control system according to an embodiment;

FIG. 2A is a diagram showing an example of a priority processing table when a processing state for a machine tool is in the MEM mode (during machine operation);

FIG. 2B is a diagram showing an example of a priority processing table when the processing state for the machine tool is the MDI mode (during machine operation);

FIG. 2C is a diagram showing an example of a priority processing table when the processing state for the machine tool is the MEM mode (during machine non-operation) or the MDI mode (during machine non-operation);

FIG. 2D is a diagram showing an example of a priority processing table when the processing state for the machine tool is the EDIT mode;

FIG. 2E is a diagram showing an example of a priority processing table when the processing state for the machine tool is the JOG mode (during machine operation) or the HND mode (during machine operation);

FIG. 2F is a diagram showing an example of a priority processing table when the processing state for the machine tool is the JOG mode (during machine non-operation) or the HND mode (during machine non-operation);

FIG. 3 is a diagram showing an example of switching the order of NC processing of a plurality of processing requests based on the priority processing table;

FIG. 4 is a flowchart for explaining the control processing of a numerical control device;

FIG. 5 is a functional block diagram showing a functional configuration example of a control system;

FIG. 6A is a diagram showing an example of a priority processing table when the processing state for a robot is the automatic operation (MEM) mode (during robot operation); and

FIG. 6B is a diagram showing an example of a priority processing table when the processing state for the robot is the automatic operation (MEM) mode (during robot non-operation).

### DETAILED DESCRIPTION OF THE INVENTION

Hereinafter, a description will be given of an embodiment of the present disclosure with reference to the drawings. Herein, a machine tool is exemplified as an industrial machine, and a numerical control device is exemplified as a control device. It should be noted that the present invention is not limited to a machine tool, and may be applicable to, for example, an industrial robot, a service robot, or the like.

### Embodiment

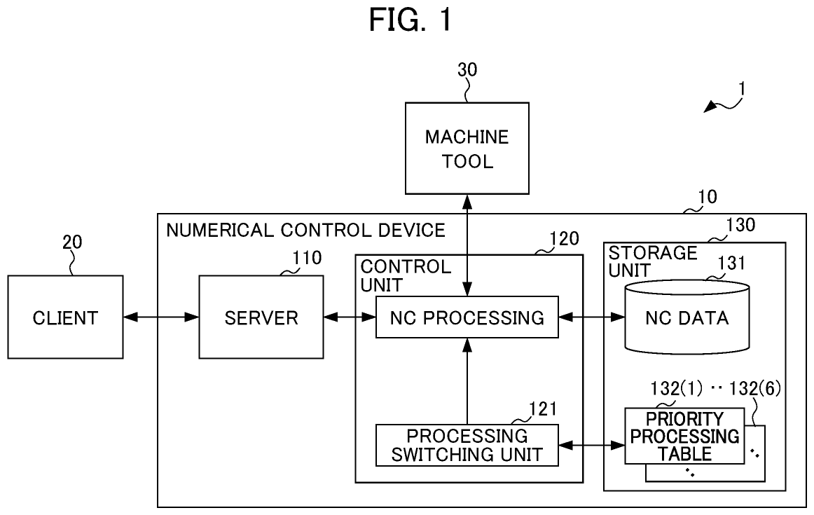

FIG. 1 is a functional block diagram showing a functional configuration example of a control system according to an embodiment. As shown in FIG. 1, the control system 1 includes a numerical control device 10, a client 20, and a machine tool 30.

The numerical control device 10, the client 20, and machine tool 30 may be directly connected to each other via a connection interface (not shown). Furthermore, the numerical control device 10, the client 20, and the machine tool 30 may be connected to each other via a network (not shown) such as a LAN (Local Area Network) or the Internet. In this case, the numerical control device 10, the client 20, and the machine tool 30 include a communication unit (not shown) for communicating with each other by such a connection.

The client 20 is, for example, a display device or a tablet. The client 20 receives an input such as a processing request from a user through an input device (not shown) such as a keyboard or a touch screen included in the client 20, and transmits the received input to the numerical control device 10 to be described later. Furthermore, the client 20 receives an output from the numerical control device 10, and displays the received output on an output device (not shown) such as a liquid crystal display included in the client 20.

The machine tool 30 is a machine tool known to those skilled in the art, and operates based on an operation command of the numerical control device 10 as a control device.

### <Numerical Control Device 10>

The numerical control device 10 is a numerical control device known to those skilled in the art, and generates an operation command based on a processing request from the client 20 or a machining program acquired from an external device (not shown) such as a CAD/CAM device, and transmits the generated operation command to the machine tool 30. Thus, the numerical control device 10 controls the operation of the machine tool 30. It should be noted that, when the machine tool 30 is a robot or the like, the numerical control device 10 may be a robot controller or the like.

As shown in FIG. 1, the numerical control device 10 includes a server 110, a control unit 120, and a storage unit 130. Furthermore, the control unit 120 includes a processing switching unit 121.

### <Server 110>

The server 110 is, for example, a Web server and communicates with the client 20. When a processing request to the numerical control device 10 is received from the client 20, the server 110 outputs the processing request to the control unit 120 which will be described later. Furthermore, the server 110 receives, from the control unit 120, the response to the processing request from the client 20, and transmits the received response to the client 20.

### <Storage Unit 130>

The storage unit 130 is RAM (Random Access Memory), a HDD (Hard Disk Drive) or the like. The storage unit 130 stores the NC data 131 and priority processing tables 132(1) to 132(6).

For example, the NC data 131 stores a machining program generated by an external device (not shown) such as a CAD/CAM device, and setting values such as a tool offset amount and a workpiece coordinate.

The priority processing tables 132(1) to 132(6) each store priority information in which the priority is set in advance to execute the NC processing of each processing request from the client 20 for each processing state for the industrial machine (hereinafter, also referred to as “processing state for the machine tool 30”), for example. It should be noted that the processing state for the machine tool 30 includes, for example, “MEM mode (during machine operation)”, “MEM mode (during machine non-operation)”, “MDI mode (during machine operation)”, “MDI mode (during machine non-operation)”, “EDIT mode”, “JOG/HND mode (during machine operation)”, and “JOG/HND mode (during machine non-operation)”.

Here, the MEM mode is a memory mode, which is a mode of automatic operation based on the machining program. In addition, the MDI mode is a mode in which a machining program for operating the machine tool 30 is inputted one line by one to operate the machine tool 30. Furthermore, the EDIT mode is a mode for editing a processing program or a processing cycle. Furthermore, the JOG mode is a mode for moving a spindle or a table (not shown) of the machine tool 30 by a user continuing to press an axis movement button (not shown) for moving each axis of the machine tool 30 included in the numerical control device 10. The HND mode is a mode in which the user manually rotates a handle (not shown) included in the numerical control device 10 to move the spindle or the table (not shown) of the machine tool 30.

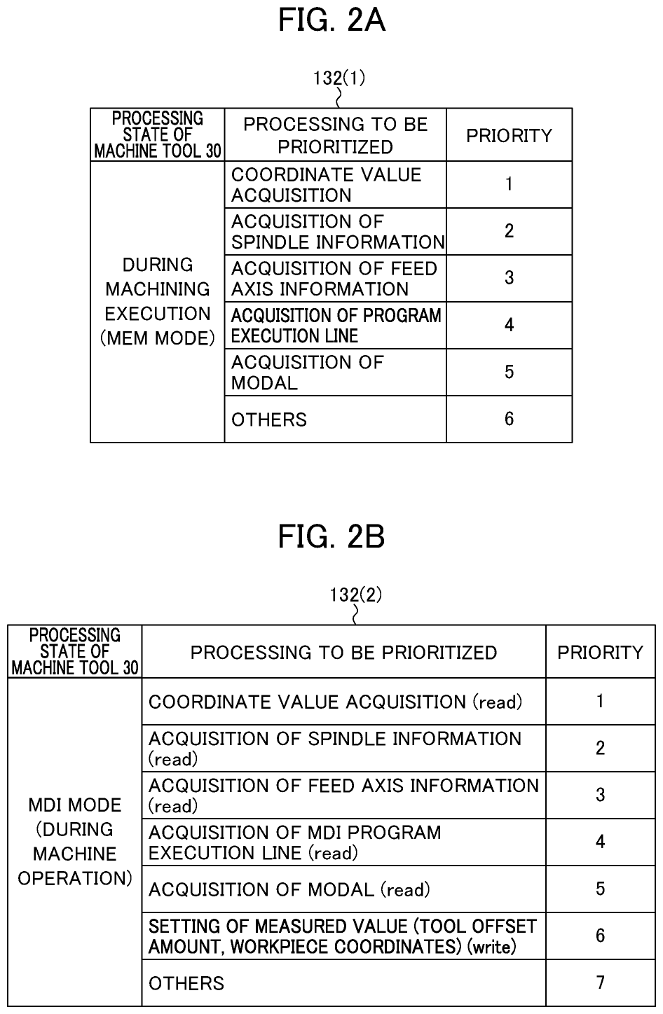

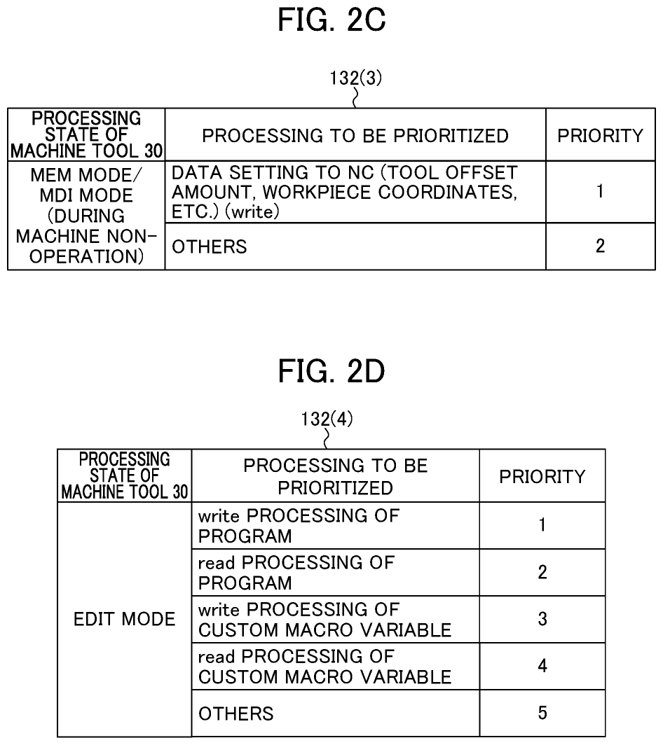

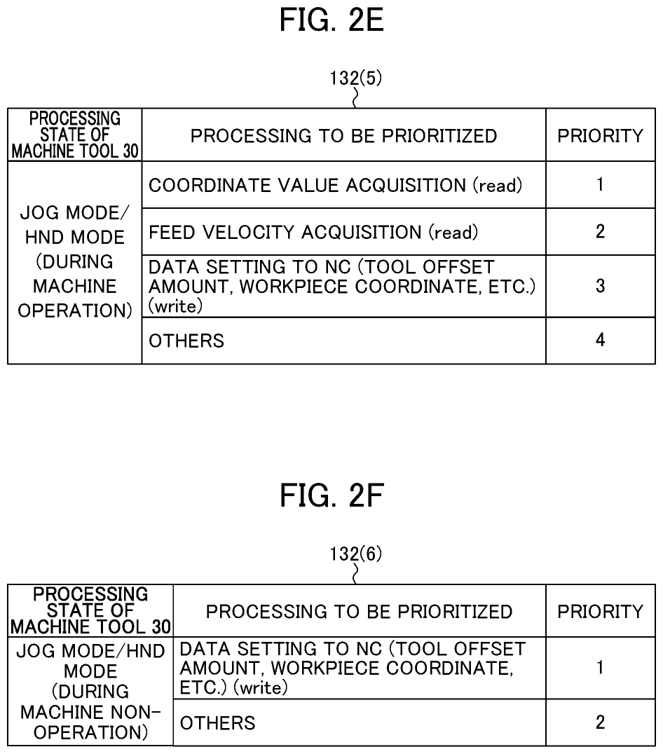

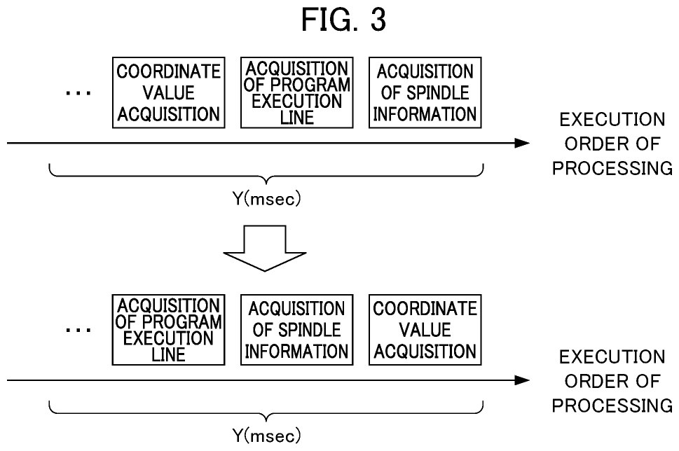

FIG. 2A is a diagram showing an example of a priority processing table 132(1) when the processing state for the machine tool 30 is the MEM mode (during machine operation).

As shown in FIG. 2A, the priority processing table 132(1) of the MEM mode (during machine operation) includes, for example, processing of “coordinate value acquisition”, “acquisition of spindle information”, “acquisition of feed axis information”, “acquisition of program execution line”, “acquisition of modal”, and “others”. Furthermore, in the priority processing table 132(1) of the MEM mode (during machine operation), a higher priority is set from those of high importance to be conscious during machining.

More specifically, for example, the highest priority “1” is set for “coordinate value acquisition” in order to perform monitoring so as not to cause interference between the tool, the workpiece, and a jig. Priority “2” is set for “acquisition of spindle information” to monitor whether the spindle is rotating at high velocity more than required, and prevent the motor from burning. Priority “3” is set for “acquisition of feed axis information” to monitor whether the operation is performed at a velocity (mm/sec) higher than expected. Priority “4” is set for “acquisition of program execution line” to know which part of the workpiece is currently being machined. Priority “5” is set for “modal acquisition” to know what modal is valid in the current number of program execution lines. Priority “6” is set for “others” which is processing other than the above.

FIG. 2B is a diagram showing an example of the priority processing table 132(2) when the processing state for the machine tool 30 is the MDI mode (during machine operation).

As shown in FIG. 2B, the priority processing table 132(2) of the MDI mode (during machine operation) includes, for example, processing of “coordinate value acquisition (read)”, “acquisition of spindle information (read)”, “acquisition of feed axis information (read)”, “acquisition of MDI program execution line (read)”, “acquisition of modal (read)”, “setting of measured values (tool offset amount, workpiece coordinate) (write)”, and “others”. Furthermore, the MDI mode (during machine operation) is used in the preparation stage (stage of setup) before machining by the machine tool 30 is performed in the MEM mode (during machine operation) described above. Therefore, in the priority processing table 132(2) of the MDI mode (during machine operation), a higher priority is set from those of high importance to be conscious during machine operation.

More specifically, for example, the highest priority “1” is set for the “coordinate value acquisition (read)” to perform monitoring so as to prevent the interference between the tool, the workpiece, and the jig from occurring, as in the case of the MEM mode (during machine operation). Priority “2” is set for “acquisition of spindle information (read)” to monitor whether the spindle is rotating at a high velocity more than required and prevent the motor from burning, as in the case of the MEM-mode (during machine operation). Priority “3” is set for “acquisition of feed axis information (read)” in order to monitor whether the operation is performed at a velocity (mm/sec) higher than expected, as in the case of the MEM mode (during machine operation). Priority “4” is set for “acquisition of MDI program execution line” to know which part of the workpiece is currently being machined, as in the case of the MEM mode (during machine operation). In the same way as in the MEM mode (during machine operating), priority “5” is set in order to understand what modal is valid in the current number of MDI program execution lines. Priority “6” is set for the “setting of measured values (tool offset amount, workpiece coordinate) (write)” in order to, for example, measure the tool length, the coordinate value of the workpiece, etc. by using a sensor (not shown) such as a touch probe installed on a spindle (not shown) of the machine tool 30, and set the tool offset amount, the workpiece coordinates, etc. in the NC data 131. Priority “7” is set for “others”, which is processing other than the above.

It should be noted that, in the aforementioned example, the reason why the processing of “coordinate value acquisition (read)”, “acquisition of spindle information (read)”, “acquisition of feed axis information (read)”, “acquisition of MDI program execution line (read)”, and “acquisition of modal (read)” takes precedence over the processing of “setting of measured values (tool offset amount, workpiece coordinate) (write)” is because the former should be known during machine operation. In addition, the processing of “setting of the measured values (tool offset amount, workpiece coordinate) (write)” is prioritized higher than the processing of “others” because the former is originally an intended operation for measurement in the MDI mode.

FIG. 2C is a diagram showing an example of a priority processing table 132(3) when the processing state for the machine tool 30 is the MEM mode (during machine non-operation) or the MDI mode (during machine non-operation).

As shown in FIG. 2C, the priority processing table 132(3) of the MEM mode (during machine non-operation) or the MDI mode (during machine non-operation) includes, for example, the processing of “data setting to the NC (tool offset amount, workpiece coordinates, etc.) (write)” and “others”. Furthermore, in the MEM mode (during machine non-operation) or the MDI mode (during machine non-operation), since the machine tool 30 is in machine non-operation, that is, in an idle state, the setup for machining of the machine tool 30 in the MEM mode (during machine operation) is performed. Therefore, in the priority processing table 132(3) of the MEM mode (during machine non-operation) or the MDI mode (during machine non-operation), for example, priority “1” is set for the “data setting to the NC (tool offset amount, workpiece coordinate, etc.) (write)” in order to set the tool offset amount, workpiece coordinate, etc. manually inputted from the numerical control device 10 or the client 20 in the NC data 131. Priority “2” is set, for example, for the “others” which is processing other than the above.

FIG. 2D is a diagram showing an example of the priority processing table 132(4) when the processing state for the machine tool 30 is the EDIT mode.

As shown in FIG. 2D, the priority processing table 132 (4) of the EDIT mode includes, for example, processing of “write processing of program”, “read processing of program”, “write processing of custom macro variable”, “read processing of custom macro variable”, and “others”. Furthermore, in the priority processing table 132(4) of the EDIT mode, a higher priority is set so as to establish the order of the NC processing from the write processing to the read processing. Thus, reading data such as a written processing program or a custom macro variable generates an effect of preventing the data of the NC data 131 from deviating from the data on the display side of the client 20 or the like.

More specifically, for example, priority “1” is set for the “write processing of program”, and priority “2” is set for the “read processing of program”. In addition, for example, priority “3” is set for the “write processing of custom macro variable”, and priority “4” is set for the “read processing of custom macro variable”. It should be noted that priority “5” is set for the “others” which is processing other than the above.

FIG. 2E is a diagram showing an example of the priority processing table 132(5) when the processing state for the machine tool 30 is the JOG mode (during machine operation) or the HND mode (during machine operation).

As shown in FIG. 2E, the priority processing table 132(5) in the case of the JOG mode (during machine operation) or in the HND mode (during machine operation) includes, for example, processing of “coordinate value acquisition (read)”, “feed velocity acquisition (read)”, “data setting to the NC (tool offset amount, workpiece coordinates, etc.) (write)”, and “others”.

It should be noted that, in the JOG mode (during machine operation), for example, a spindle or the table (not shown) of the machine tool 30 is moved by a user continuing to press an axis movement button (not shown) for moving each axis of the machine tool 30 included in the numerical control device 10 to be described later. Furthermore, in the HND mode (during machine operation), for example, by a handle (not shown) included in the numerical control device 10 to be described later being manually rotated by the user, the spindle or the table (not shown) of the machine tool 30 is moved. Therefore, in the priority processing table 132(5) in the case of the JOG mode (during machine operation) or the HND mode (during machine operation), a higher priority may be set for those of higher importance to be conscious during machine operation, as in the case of the MDI mode (during machine operation).

More specifically, priority “1” is set for “coordinate value acquisition (read)” in order to perform monitoring so as to prevent interference between the tool, the workpiece, and the jig from occurring. Priority “2” is set for “feed velocity acquisition (read)” in order to know whether the operation is performed at a velocity more than expected. Priority “3” is set for “data setting to the NC (tool offset amount, workpiece coordinates, etc.) (write)”, for example, in order to measure the tool length, the coordinate value of the workpiece, etc., by using a sensor (not shown) such as a touch probe installed in a spindle (not shown) of the machine tool 30, and set the tool offset amount, the workpiece coordinates, etc. in the NC data 131. Priority “4” is set for “others” which is processing other than the above.

FIG. 2F is a diagram showing an example of the priority processing table 132(6) when the processing state for the machine tool 30 is the JOG mode (during machine non-operation) or the HND mode (during machine non-operation).

As shown in FIG. 2F, the priority processing table 132(6) in the case of the JOG mode (during machine non-operation) or the HND mode (during machine non-operation) includes, for example, processing of “data setting to the NC (tool offset amount, workpiece coordinates, etc.) (write)” and “others”. Furthermore, in the JOG mode (during machine non-operation) or the HND mode (during machine non-operation), since the machine tool 30 is in machine non-operation, that is, in an idle state, the setup for machining of the machine tool 30 in the MEM mode (during machine operation) is performed. Therefore, in the priority processing table 132(7) of the JOG mode (during machine non-operation) or the HND mode (during machine non-operation), priority “1” is set for “data setting to the NC (tool offset amount, workpiece coordinates, etc.) (write)” in order to set the tool offset amount, workpiece coordinates, etc. manually inputted from the numerical control device 10 or the client 20 to the NC data 131. Priority “2” is set for “others” which is processing other than the above.

As described above, the plurality of priority processing tables 132(1) to 132(6) is exemplified according to the processing state for the machine tool 30. However, these are merely examples, and the present invention is not limited thereto. The user may set the priority processing table 132 as appropriate.

In the following, when there is no need to distinguish each of the priority processing tables 132 (1) to (6) individually, these are collectively referred to as “priority processing table 132”.

### <Control Unit 120>

The control unit 120 includes a CPU (Central Processing Unit), ROM (Read Only Memory), RAM, CMOS (Complementary Metal-Oxide Semiconductor) memory, and the like, which are known to those skilled in the art, configured to communicate with each other via a bus.

The CPU is a processor that generally controls the numerical control device 10. The CPU reads the system program and the application program stored in the ROM through the bus, and controls the entire numerical control device 10 in accordance with the system program and the application program. Thus, as shown in FIG. 1, the control unit 120 is configured to realize the function of the processing switching unit 121. Various data such as temporary calculation data and display data are stored in the RAM. Furthermore, the CMOS memory is backed up by a battery (not shown), and is configured as nonvolatile memory in which the stored state is retained even when the power of the numerical control device 10 is turned off.

Furthermore, the control unit 120 executes NC processing for the processing request received from the client 20, and outputs an operation command to the machine tool 30.

More specifically, in a case in which there is a plurality of unprocessed processing requests received from the client 20, the control unit 120 executes the NC processing of each of the plurality of processing requests in the order switched by the processing switching unit 121 to be described later based on the priority processing table 132 according to the processing state for the machine tool 30. It should be noted that the NC processing by the control unit 120 will be described later.

Furthermore, the control unit 120 may read the machining program of the NC data 131, execute the NC processing based on the machining program thus read, and output an operation command to the machine tool 30.

The processing switching unit 121 switches the order of the NC processing for each of the unprocessed plurality of processing requests received from the client 20 based on the priority processing table 132 according to the processing state for the machine tool 30.

More specifically, in a case in which the processing state for the machine tool 30 is the “MEM mode (during machine operation)”, for example, the processing switching unit 121 reads the priority processing table 132(1) from the storage unit 130. Furthermore, based on the priority processing table 132 (1) thus read, the processing switching unit 121 switches the processing order so as to process the NC processing of each of the plurality of unprocessed processing requests received from the client 20 in the order of higher priority.

FIG. 3 is a diagram showing an example of switching the order of NC processing of a plurality of processing requests based on the priority processing table 132 (1). The upper part of FIG. 3 shows a plurality of processing requests that are unprocessed in the order received from the client 20. The lower part of FIG. 3 shows the order of unprocessed processing requests switched in the order of higher priority based on the priority processing table 132 (1). It should be noted that the same applies to the priority processing tables 132(2) to 132(6) as in the case of the priority processing table 132(1).

As shown in the upper part of FIG. 3, when the processing state for the machine tool 30 is the MEM mode (during machine operation), if the unprocessed plurality of processing requests received from the client 20 is “acquisition of spindle information”, “acquisition of program execution line”, “coordinate value acquisition”, or the like, the processing switching unit 121 performs switching in the order of “coordinate value acquisition” having priority “1”, “acquisition of spindle information” having priority “2”, “acquisition of the program execution line” having priority “4”, or the like, based on the priority processing table 132(1) thus read. Thereafter, as shown in the lower row of FIG. 3, the control unit 120 executes the NC processing in the order of the processing requests such as “coordinate value acquisition”, “acquisition of spindle information”, and “acquisition of program execution line”, switched by the processing switching unit 121.

In this way, the numerical control device 10 can preferentially execute, for example, processing for displaying on the client 20 side such as “coordinate value acquisition” and processing for reflecting data on the numerical control device 10 side such as “data setting to the NC (tool offset amount, workpiece coordinates, etc.) (write)”. This makes it possible to suppress the delay of processing to be immediately performed.

It should be noted that the plurality of processing requests may be received from the client 20 at a time, or may be sequentially received from the client 20 and stored in memory (not shown) such as RAM included in the numerical control device 10.

### <Control Processing of Numerical Control Device 10>

Next, a description will be given of operation according to the control processing of the numerical control device 10 of the present embodiment.

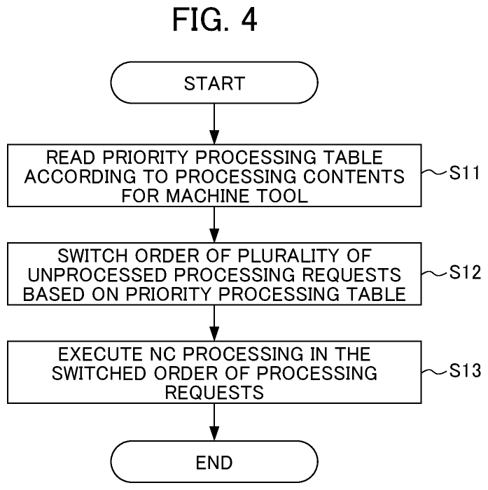

FIG. 4 is a flowchart for explaining the control processing of the numerical control device 10.

In Step S11, the processing switching unit 121 reads the priority processing table 132 in accordance with the processing state for the machine tool 30.

In Step S12, the processing switching unit 121 switches the order of the NC processing for each of the plurality of unprocessed processing requests received from the client 20 in the order of higher priority based on the priority processing table 132 thus read in Step S11.

In Step S13, the control unit 120 executes the NC processing in the order of higher processing request priority switched in Step S12.

With such a configuration, in a case in which there is a plurality of unprocessed processing requests received from the client 20, the numerical control device 10 according to an embodiment switches the NC processing for each of the plurality of unprocessed processing requests in the order of higher priority based on the priority processing table 132 according to the processing state for the machine tool 30, and executes the NC processing of the processing request having higher priority.

Thus, the numerical control device 10 can execute the processing to be prioritized for each processing state of the machine tool 30, which makes it possible to suppress the delay of the processing to be performed immediately.

Although one embodiment has been described above, the numerical control device 10 is not limited to the above-described embodiment, and includes modifications, improvements, and the like within a scope that can achieve the purpose.

### Modification Example 1

In the above-described embodiment, the numerical control device 10 switches the order of the NC processing for the plurality of unprocessed processing requests received from the client 20 based on the priority processing table 132 according to the processing state for the machine tool 30, and executes the NC processing for each processing request in the switched order. However, the present invention is not limited thereto. For example, the numerical control device 10 may monitor the processing load of the numerical control device 10, the communication load with the client 20, and the processing load of the server 110. Furthermore, in a case in which any of the loads is higher than a predetermined value, the numerical control device 10 may switch the order of the NC processing for the plurality of unprocessed processing requests received from the client 20 based on the priority processing table 132, and execute the NC processing for each processing request in the switched order.

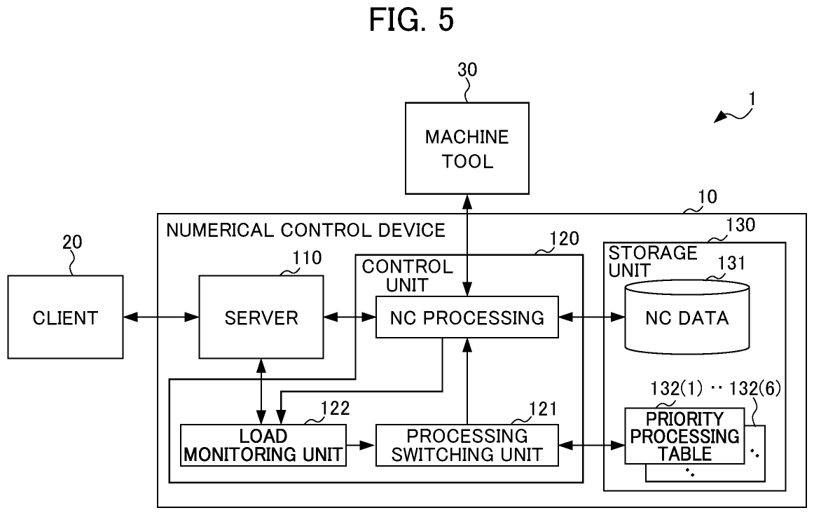

FIG. 5 is a functional block diagram showing a functional configuration example of a control system.

As shown in FIG. 5, the control unit 120 of the numerical control device 10 has the function of a load monitoring unit 122 that monitors the processing load of the numerical control device 10, the communication load with the client 20, and the processing load of the server 110. Furthermore, the load monitoring unit 122 outputs a monitoring result to the processing switching unit 121. Based on the monitoring result from the load monitoring unit 122, in a case in which any load among the processing load of the numerical control device 10, the communication load between the client 20 and the server 110, and the processing load of the server 110 is higher than a predetermined value, the processing switching unit 121 reads the priority processing table 132 according to the processing state of the machine tool 30. The processing switching unit 121 switches the order of the NC processing for the plurality of unprocessed processing requests received from the client 20 based on the priority processing table 132 according to the processing state for the machine tool 30.

In this way, the numerical control device 10 can execute the processing to be prioritized for each processing state of the machine tool 30 even in a case in which any of the processing load of the numerical control device 10, the communication load between the client 20 and the server 110, and the processing load of the server 110 becomes high, and hence, it is possible to suppress the delay of the processing to be immediately performed.

It should be noted that the predetermined value may be appropriately set according to the processing capability of the numerical control device 10, the reception frequency of the processing request from the client 20, etc.

### Modification Example 2

For example, in the above-described embodiment, the numerical control device 10 switches the order of the NC processing for each of the plurality of unprocessed processing requests received from the client 20 based on the priority processing table 132 according to the processing state for the machine tool 30. However, the present invention is not limited thereto. For example, in a case in which the processing state for the machine tool 30 has changed after the switching, the numerical control device 10 may again switch the order of the NC processing for each of the plurality of unprocessed processing requests from the client 20 based on the priority processing table 132 after the change.

### Modification Example 3

In the embodiments and modification examples described above, the numerical control device 10 has the priority processing tables 132(1) to 132(6) according to the processing state for the machine tool 30. However, the present invention is not limited thereto. For example, in the case of the industrial machine being a robot, the robot controller as a control device (not shown) may have a priority processing table according to the processing state for the robot (not shown).

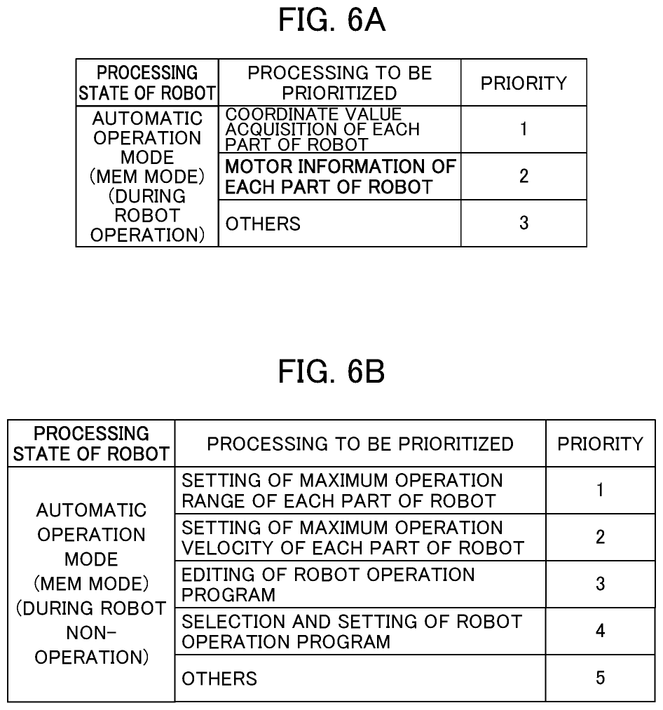

FIG. 6A is a diagram showing an example of a priority processing table when the processing state for the robot is an automatic operation (MEM) mode (during robot operation).

As shown in FIG. 6A, the priority processing table of the automatic operation (MEM) mode (during robot operation) includes, for example, processing of “coordinate value acquisition of each part of robot”, “motor information of each part of robot”, and “others”. Furthermore, in the priority processing table of the automatic operation (MEM) mode (during robot operation), similarly to the case of the priority processing table 132(1) of the MEM mode (during machine operation), a higher priority is set from those of high importance to be conscious during machining.

More specifically, the highest priority “1” is set for “coordinate value acquisition of each part of robot” in order to perform monitoring so as to prevent, for example, an arm of the robot from interfering with a peripheral device. Priority “2” is set for “motor information of each part of robot”, for example, to monitor whether the load is too high to prevent motor failure. Priority “3” is set for “others” which is processing other than the above.

FIG. 6B is a diagram showing an example of a priority processing table when the processing state of the robot is the automatic operation (MEM) mode (during robot non-operation).

As shown in FIG. 6B, the priority processing table of the automatic operation (MEM) mode (during robot non-operation) includes, for example, processing of “setting of maximum operation range of each part of robot”, “setting of maximum operation velocity of each part of robot”, “editing of robot operation program”, “selection and setting of robot operation program”, and “others”. Furthermore, in the priority processing table of the automatic operation (MEM) mode (during robot non-operation), since the machine tool is non-operation, i.e. the idle state, various settings to the robot are prioritized for performing the various settings to the robot.

More specifically, the highest priority “1” is set for “setting of maximum operation range of each part of robot”, for example, since this setting leads to accident prevention. Since “setting of maximum operation velocity of each part of robot” is a setting that minimizes damage even if a collision occurs, priority “2” is set for this setting, for example. Priority “3” is set for “editing of robot operation program”, for example, in order to designate and set the robot operation. Priority “4” is set for “selection and setting of robot operation program”, for example, to select and set the program for an operation to the robot. Priority “5” is set for “others” which is processing other than the above. It should be noted that “selection and setting of robot operation program” is setting that is required to set the processing in which program editing has been completed. For this reason, the priority is lower than that of “editing of robot operation program”.

Although the plurality of priority processing tables has been exemplified in accordance with the processing state for the robot, these are merely examples, and the present invention is not limited thereto. The user may set the priority processing table as appropriate.

It should be noted that each function included in the numerical control device 10 according to an embodiment can be realized by hardware, software or a combination thereof. Here, being realized by software indicates being realized by a computer reading and executing a program.

The programs can be stored using any of various types of non-transitory computer readable media, and be provided to a computer. The non-transitory computer readable media include various types of tangible storage media. Examples of non-transitory computer readable media include magnetic recording media (e.g., flexible disks, magnetic tapes, hard disk drives), magneto-optical media (e.g., magneto-optical disks), CD-ROM (Read Only Memory), CD-R, CD-R/W, semiconductor memory (e.g., mask ROM, PROM (Programmable ROM), EPROM (Erasable PROM), flash ROM, RAM). The programs may be provided to a computer by using any of various types of transitory computer readable media. Examples of the transitory computer readable media include electric signals, optical signals, and electromagnetic waves. A transitory computer readable medium can provide programs to a computer through a wired communication path such as an electrical cable, an optical fiber, or the like or a wireless communication path.

A step of writing programs to be recorded on a recording medium includes processing that is performed in a time series manner according to the order and processing that is performed in a parallel or independent manner even if the processing is not necessarily performed in a time series manner.

In other words, the control device and the control method of the present disclosure may assume various embodiments having the following configuration.

(1) The numerical control device 10 according to the present disclosure is a control device that executes processing of processing requests for a machine tool 30 from a client 20, the numerical control device 10 including: a processing switching unit 121 configured to switch, in a case in which a plurality of the processing requests is received from the client 20, an order of processing for each of the plurality of processing requests based on a priority according to a processing state for the machine tool 30.

According to the numerical control device 10, it is possible to reliably execute the processing to be prioritized for each processing state for the machine tool 30.

(2) The numerical control device 10 according to (1), further including a priority processing table 132 that stores priority information indicating priority for executing processing of each of the processing requests for each processing state for the machine tool 30, in which the processing switching unit 121 may switch the order of processing for each of the plurality of processing requests based on the priority information according to a processing state for the machine tool 30.

In this way, it is possible to reliably execute the processing to be prioritized for each processing state for the machine tool 30, and hence, it is possible to suppress the delay of the processing to be performed immediately.

(3) The numerical control device 10 according to (1) or (2), further including: a server 110 configured to communicate with the client 20; and a load monitoring unit 122 configured to monitor at least one load among a processing load in the numerical control device 10, a communication load with the client 20, and a processing load in the server 110, in which the processing switching unit 121 may switch, in a case in which the load monitored by the load monitoring unit 122 is larger than a predetermined value, the order of processing for each of the plurality of the processing requests based on the priority according to a processing state for the machine tool 30.

In this way, even when any of the processing load of the numerical control device 10, the communication load between the client 20 and the server 110, and the processing load of the server 110 becomes high, it is possible to execute the processing to be prioritized for each processing state of the machine tool 30, and hence, it is possible to suppress the delay of the processing to be immediately performed.

(4) The numerical control device 10 according to any one of (1) to (3), in which the industrial machine may be the machine tool 30, and the control device may be the numerical control device 10.

In so doing, the effects of (1) to (3) can be achieved when the industrial machine is the machine tool 30.

(5) The numerical control device 10 according to any one of (1) to (3), in which the industrial machine is an industrial robot, and the control device is a robot control device.

In doing so, the effects of (1) to (3) can be achieved when the industrial machine is an industrial robot.

(6) A control method according to the present disclosure is a control method for executing processing of processing requests for a machine tool 30 from a client 20, the method including: switching, in a case in which a plurality of the processing requests is received from the client 20, an order of processing for each of the plurality of the processing requests based on a priority according to a processing state for the machine tool 30.

According to this control method, it is possible to achieve the same effect as (1).

### EXPLANATION OF REFERENCE NUMERALS

1 control system
10 numerical control device
20 client
30 machine tool
110 server
120 control unit
121 processing switching unit
130 storage unit
131 NC data
132(1)-132(6) priority processing table

What is claimed is:

1. A control device that executes processing of processing requests for an industrial machine from a client, the control device comprising:
a processing switching unit configured to switch, in a case in which a plurality of the processing requests is received from the client, an order of processing for each of the plurality of processing requests based on a priority according to a processing state for the industrial machine.

2. The control device according to claim 1, further comprising a priority processing table that stores priority information indicating priority for executing processing of each of the processing requests for each processing state for the industrial machine,
wherein the processing switching unit switches the order of processing for each of the plurality of processing requests based on the priority information according to a processing state for the industrial machine.

3. The control device according to claim 1, further comprising:
a server configured to communicate with the client; and
a load monitoring unit configured to monitor at least one load among a processing load in the control device, a communication load with the client, and a processing load in the server,
wherein the processing switching unit switches, in a case in which the load monitored by the load monitoring unit is larger than a predetermined value, the order of processing for each of the plurality of the processing requests based on the priority according to a processing state for the industrial machine.

4. The control device according to claim 1, wherein the industrial machine is a machine tool, and the control device is a numerical control device.

5. The control device according to claim 1, wherein the industrial machine is an industrial robot, and the control device is a robot control device.

6. A control method for executing processing of processing requests for an industrial machine from a client, the method comprising:
switching, in a case in which a plurality of the processing requests is received from the client, an order of processing for each of the plurality of the processing requests based on a priority according to a processing state for the industrial machine.
